(19) United States
(12) Patent Application Publication
(10) Pub. No.: US 2026/0263942 A1
(43) Pub. Date: Sep. 10, 2026

(54) GAME STATE CREATION IN A GAMING ENVIRONMENT

(71) Applicant: Sony Interactive Entertainment Europe Limited, London (GB)

(72) Inventors: Jesus Lucas Barcias, London (GB); Matthew William Sanders, London (GB); Rosario Leonardi, London (GB); Marcos Conde, London (GB)

(21) Appl. No.: 19/561,815

(22) Filed: Mar. 10, 2026

(30) Foreign Application Priority Data
Mar. 10, 2025 (GB) 2503489.3

(51) Int. Cl. A63F 13/67; A63F 13/52; A63F 13/54

(52) U.S. Cl. CPC A63F 13/67; A63F 13/52; A63F 13/54

(57) ABSTRACT

A computer-implemented method of generating a game state in a computer-generated gaming environment, comprising: obtaining game play data associated with a user; determining at least one characteristic of the user in the computer-generated gaming environment using a trained artificial intelligence model which has been trained to map the game play data associated with the user to the at least one characteristic of the user; allocating computing resources for generating the game state based on the determined at least one characteristic of the user; and generating the game state in the computer-generated gaming environment using the allocated computing resources.

### CROSS-REFERENCE TO RELATED APPLICATIONS

This application claims priority to United Kingdom Application No. 2503489.3, filed on March 10, 2025, the contents of which are incorporated herein by reference.

### Field of the Invention

The present specification relates to computer-implemented systems and methods for generating a game state in a computer-generated gaming environment.

### BACKGROUND

To satisfy game users’ growing needs, modern computer games are becoming more and more complicated, e.g., with more in-game activities, game add-ons, multiuser interactions, and/or better visual rendering (e.g., higher resolution, more visual features), etc. While a strong and sufficient computing power is always a key enabler for implementing complicated computer games, in many cases, it may not be sustainable and/or cost effective to keep on increasing computing resources.

A better or optimal allocation of computing resources allows existing computing resources to be used in a more efficient and effective manner and thus enables a higher computing power without needing more computing resources. This in turn allows for a better gaming experience. Therefore, it is desirable to further improve the allocation of computing resources provided to support a computer-generated gaming environment in which a computer game is played.

Aspects and embodiments are conceived with the foregoing in mind.

### SUMMARY

According to a first aspect of the present disclosure, there is provided a computer-implemented method of generating a game state in a computer-generated gaming environment. The method may comprise: obtaining game play data associated with a user; determining at least one characteristic of the user in the computer-generated gaming environment using a trained artificial intelligence model which has been trained to map the game play data associated with the user to the at least one characteristic of the user; allocating computing resources for generating the game state based on the determined characteristic of the user; and generating the game state in the computer-generated gaming environment using the allocated computing resources.

The method may be implemented by a processing resource. A processing resource may be implemented using a cloud-implemented computing resource or using a local computing resource. A processing resource may be any resource which can provide computer processing capability. A computer-generated gaming environment may mean a virtual or augmented reality environment which is provided through one or more computing devices where a computer game is to be rendered and inputs into that computer game are to be implemented and/or rendered.

The method allows a computing system to optimally allocate, based on one or more user characteristics predicted by an artificial intelligence model, its computing resources for generating a game state in a computer implemented gaming environment provided by the computing system. The use of a trained artificial intelligence model allows for an efficient and accurate prediction of user characteristics. When implemented in a computing system (e.g., a gaming system), the method is capable of improving the system’s efficiency, thereby providing a better user experience.

In an embodiment, the trained artificial intelligence model may comprise a trained neural network model. The neural network may be an artificial neural network (ANN). ANNs are otherwise known as connectionist systems which are computing systems which are vaguely inspired by biological neural networks. Such systems “learn” tasks by considering examples, generally without task-specific programming. They do this without any prior knowledge about the task or tasks, and instead, they evolve their own set of relevant characteristics from the learning/training material that they process. ANNs are considered nonlinear statistical data modelling tools where the complex relationship between inputs and outputs are modelled or patterns are found. ANN may be hardware (where neurons are represented by physical components) or software-based (computer models) and can use a variety of topologies and learning algorithms. It will be appreciated that other feedforward models (e.g., a trained regression tree model) may also be applicable for predicting/determining user characteristics based on game play data.

In an embodiment, the method may further comprise training a neural network model on training data to obtain the trained neural network model. Training data may comprise a user’s own game play data either generated in the past or being generated if the user is playing a game, and/or other users’ game play data if such other users have been determined to possess similar user characteristics (e.g., on a similar competence level in playing a computer game). Such training may be supervised, based on known input game play data and corresponding user characteristics. In order to establish a well-performing prediction model with a neural network, the training data should comprise a sufficiently representative data set. This data set may contain enough game play data that is linked to various different characteristics of a game player. In an embodiment, said training may comprise applying a stochastic gradient descent algorithm on said training data. In an embodiment, the neural network may be trained using reinforcement learning.

In an embodiment, the game play data associated with the user may comprise inputs of the user in response to one or more game states provided as part of a computer game in the computer-generated gaming environment. The inputs which the user uses to respond to a game state may be described as a response action which comprises at least one input which are received from a computing device to be interpreted and/or rendered in the computer-generated gaming environment. In an embodiment, the game play data associated with the user may further comprise one or more indications respectively for indicating the one or more game states. In an embodiment, the game play data associated with the user may further comprise a length of time taken by the user to provide inputs in response to each game state. In an embodiment, the game play data associated with the user may further comprise an amount of computing resources used to generate each of the one or more game states.

In an embodiment, the at least one characteristic of the user may comprise a competence level of the user in the computer-generated gaming environment. The competence level of the user may be determined based on historic game play data or based on user input from the user. The historic game play data may comprise game play data obtained in association with other users of the computer-generated gaming environment or other computer generated gaming environments. In alternative embodiments, the at least one characteristic of the user may comprise indications that can directly or indirectly reflect a degree of familiarity of the user with the game. Such indications may comprise for example a total accumulated time the user has played the game to date, and/or a total number of game states the user has encountered in the game to date, and/or a total score in the game to date.

In other embodiments the at least one characteristic may comprise responsiveness levels, the likelihood to take certain courses of action, game state consumption, faster or slower inputs or any other characteristic which can be based on a game users interaction with a computer-generated gaming environment. These characteristics can be determined based on game play data which indicates such a characteristic can be associated with a user. A game user’s tendency to take a specific course of action means they are likely to take that course of action again and that course of action, as a characteristic, may be used to allocate computing resources which can be used in the generation of a game state.

In an embodiment, the step of allocating computing resources for generating the game state may comprise determining at least one aspect of the game state. In an embodiment, the at least one aspect of the game state may further comprise one or more of:

presence of one or more visual components of the game state;

presence of one or more audio components of the game state;

presence of one or more tactile cues of the game state; and

a rendering resolution of one or more visual components of the game state.

In an embodiment, the step of generating the game state in the computer-generated gaming environment may comprise: obtaining multimedia content associated with the game state, said multimedia content being determined by the allocated computing resources; and rendering said multimedia content of the game state. In an embodiment, said multimedia content may comprise one or more visual components. In an embodiment, said multimedia content may comprise one or more audio components. In an embodiment, said multimedia content may comprise one or more tactile cues which may lead to the generation of haptic feedback through a device through which user input is received. Obtaining the multimedia content associated with the game state may comprise obtaining the multimedia content from a content provider.

According to a second aspect of the present disclosure, the disclosure provides a computer program comprising program instructions operable to perform the method of the first aspect, when run on a suitable apparatus.

According to a third aspect of the present disclosure, the disclosure provides a computer-readable storage medium comprising the computer program of the second aspect.

According to a fourth aspect of the present disclosure, the disclosure provides a processing resource configured to implement the method of the first aspect.

According to a fifth aspect of the present disclosure, the disclosure provides a system comprising the processing resource of the fourth aspect.

### BRIEF DESCRIPTION OF THE DRAWINGS

Illustrative embodiments of this disclosure will be described hereinafter, by way of example only, with reference to the accompanying drawings in which like reference signs relate to like elements and in which:

FIG. 1 shows a schematic illustration of a system for generating a gaming environment in which a computer game can be played, in accordance with an embodiment of the present disclosure;

FIG. 2 shows a schematic illustration of an example neural network suitable for use in the system of FIG. 1; and

FIG. 3 is a flowchart of a method of generating a game state in a computer-generated gaming environment, in accordance with an embodiment of the present disclosure.

### DETAILED DESCRIPTION

FIGS. 1 to 3 are associated with embodiments of a computer-implemented method of generating a game state in a computer-generated gaming environment and a system in which the method can be performed. The computer-implemented method may comprise obtaining game play data associated with a user; determining at least one characteristic of the user in the computer-generated gaming environment using a trained artificial intelligence model which has been trained to map the game play data associated with the user to the at least one characteristic of the user; allocating computing resources for generating the game state based on the determined at least one characteristic of the user; and generating the game state in the computer-generated gaming environment using the allocated computing resources.

In an aspect of the present disclosure, there is provided a system for providing a computer-generated gaming environment in which a computer game can be played. With reference to FIG. 1, in an embodiment, the system 100 comprises computing device 102 configured to interact with cloud resource 104 to implement a computer-generated gaming environment on the computing device 102. That is to say, the computing device 102 provides an interface with a computer-generated gaming environment provided by the cloud resource 104 in that commands from a user which need to be interpreted in the computer-generated gaming environment are received through the computing device 102, transmitted to the cloud resource 104 and processed by the cloud resource 104 before the command is implemented inside the computer-generated gaming environment by cloud resource 104. For example, this may be a command to move a character inside the computer-generated gaming environment which requires a button press on computing device 102 to implement the movement of that character inside the computer-generated gaming environment by rendering that movement in a way in which it can be visualised on the computing device 102.

The computing device 102 may be a mobile telephone or any other device capable of providing an interface to a computer-generated gaming environment. The computing device 102 may be augmented reality or virtual reality headset which can enable access to a computer-generated gaming environment which is provided using augmented reality or virtual reality techniques.

A command from the user may be in the form of a series or sequence of button presses or other inputs into a user interface. These may be input from a controller which is part of the computing device 102 either as an integral part of the computing device 102 or a peripheral device to the computing device 102. The command may be input by the user who may want a character in the computer-generated gaming environment to perform a specific action or series of actions which is then rendered by the cloud resource 104 inside the computer-generated gaming environment. A command from the user may alternatively or additionally be in the form of a registration by the user interface or a device associated with the user interface of series of movements from the user or a series of voice commands from the user.

In an embodiment, the computing device 102 may be one of a plurality of computing devices (not shown) which are all similarly interacting with the cloud resource 104 as part of a multiuser gaming environment which is provided by the cloud resource 104 during game play by a user of the computing device 102.

In an embodiment, some of the processing which is necessary to provide the computer-generated gaming environment on a computing device may be executed on the computing device 102 or one of the other computing devices instead of the cloud resource 104. In an embodiment, the entire processing which is necessary to provide the computer-generated gaming environment on a computing device may be executed on the cloud resource 104. Note that the cloud resource 104 used in the embodiment of FIG. 1 is only an example, it will be appreciated that any suitable processing resource could be used for the same purpose.

The interaction between the computing device 102 (or any of the other computing devices) and the cloud resource 104 is enabled using any suitable telecommunications network.

The cloud resource 104 comprises a resource allocation module 106 which is configured to provide input to a user characteristic neural network module 108 and to receive output from the user characteristic neural network module 108. This interaction is enabled using any suitable telecommunications network. The input data provided by the resource allocation module 106 to the user characteristic neural network module 108 may comprise for example information associated with a specific user (e.g., data associated with a specific user profile created in a computer game) and information associated with a computer game (e.g., data associated with a specific game state of a computer game) that is being or about to be played by the user. The output data from the user characteristic neural network module 108 may comprise one or more characteristics of the user.

The user characteristic neural network module 108 comprises a trained artificial intelligence model which has been trained to map the game play data associated with a user (a game user) to the at least one characteristic of the user.

In another aspect of the present disclosure, there is provided a method of generating a game state in a computer-generated gaming environment. Such a method may be implemented by a processing resource, such as for example the system 100 of FIG. 1. The implementation of the method may allow the system 100 to better or optimally allocate its computing resources, thereby improving the efficiency of the system 100 and the gaming experience. For example, more computing resources may be allocated to certain aspects of a game state having higher priorities than other aspects of the game state.

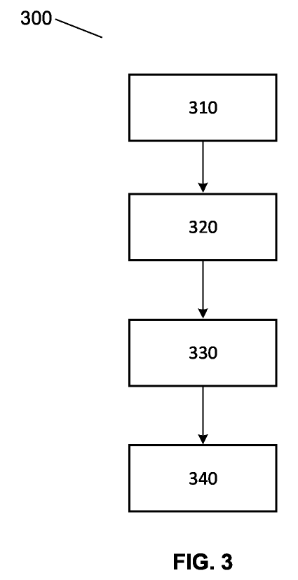

With reference to FIG. 3, in an embodiment, the method 300 comprises four main steps 310-340, which will be described in detail in the context of the system 100 of FIG. 1.

In step 310, the user characteristic neural network module 108 may be operable to obtain game play data associated with a user. To obtain the desired game play data, the user characteristic neural network module 108 may first obtain information that identifies the user (e.g., identity data of the user). The user characteristic neural network module 108 may receive the user’s information from the cloud resource 104 via the resource allocation module 106. The cloud resource 104 may be operable to retrieve the user’s information after the user has logged into their existing online account for a computer game, or if the computer game is new to the user, after the user has created a new online account for the game. In an embodiment, a unique user identifier (e.g., an identification number) may be assigned to each user when they are creating an online account for a computer game. Such a user identifier may then be used as at least part of the user’s information.

Upon obtaining the user’s information, the user characteristic neural network module 108 may be operable to send a request for game play data to the user data module 118. The request may comprise the information (e.g., the unique user identifier) of the user and a command for transmitting the game play data associated with the user. The user data module 118 may comprise a database and/or be in communication with a remote database. The user data module 118 may be configured to store and/or update one or more users’ or users’ history within a computer game provided by the computer-generated gaming environment. The user data module 118 may be located separately to or as part of the cloud resource 104 or the user presence generation module 106 or the user presence neural network module 108.

Upon receiving the request from the user characteristic neural network module 108, the user data module 118 may be configured to identify the game play data associated with the user and transmit such game play data to the user characteristic neural network module 108.

In an embodiment, in addition to the user’s information, the cloud resource 104 may be operable to send an indication of the to-be-generated (or next) game state to the user characteristic neural network module 108 which may be operable to send a request for game play data together with the indication of the to-be-generated (or next) game state to the user data module 118. The user data module 118 may only retrieve the part of the game play data generated when the user was encountering the same game state.

In an embodiment, the user data module 118 may comprise a database containing a plurality of entries each corresponding to one user. Each of the plurality of entries of the database may contain a unique user identifier that has been assigned to a user (e.g., when the user was creating an account for a computer game) and game play data associated with the user. Thus, the user data module 118 may search the database entries using the received user identifier. Once the received user identifier matches one contained in any of the plurality of entries in the database, the game play data contained in that entry will be retrieved and transmitted by the user data module 118 to the user characteristic neural network module 108.

An entry may be created in the database of the user data module 118 as soon as a user has created an account for a computer game. After an entry has been created in the database of the user data module 118, game play data generated while the user is playing the computer game may then be stored and/or updated in the entry. For example, on encountering a game state, a user may use the first computing device 102 to provide a response action as a series of inputs which will be interpreted by the cloud resource 104 and rendered within the game as a response action which will move the user from a first game state to a second game state. As the user engages with the game and encounters each of the game states of the game, their response actions and indications of the corresponding game states (i.e. identifiers or vectors of data items representing the respective game states) may be stored as the game play data. In an embodiment, the game play data may further comprise data indicating a length of time spent by the user to provide inputs in response to each game state. In an embodiment, the game play data may further comprise data indicating an amount of computing resources that have been used to complete the game state. Either of the response speed and the amount of the computing resources may indicate a level of competence of the user in playing the computer game. This is because a user who spends more time providing a response action to a game state may require more parts of the game state to be rendered than one who spends less time responding to the same game state.

In general, game play data is the data captured about a user’s interaction with the computer game environment. In some embodiments, the game play data and the associated response speed to a game state may not be the sole determinant in allocating computing resources for generation of a game state. Game play data may alternatively or additionally record one or more other metrics which can be used to determine a characteristic of the user in the computer game. The metrics may include one or more of how quickly or slowly a game user responds to a game state (this will determine how long the resources for the game state are likely to be needed), how much of the game state is consumed (this will determine how much of the audio and visual cues of the game state will likely need to be rendered), how quickly the audio and visual cues of the game state are traversed (this will determine how long a specific set of audio and visual cues within a game state are likely to be required and thus how long the resources to render and generate those cues are likely to be required), how fast the user provides input to move a character (this will determine how quickly the rendering of the character will need to be updated and re-rendered and the allocated resources for doing so), which attacks a game user likes to use (this will determine which resources likely need to be allocated to rendering an attack within a game state whilst occupied by that user)

The storing and/or updating of the game play data may be done automatically and optionally on command. The cloud resource 104 may be operable to, periodically or intermittently, send the game play data to the user data module 118 which will store or update the corresponding entry of the database. In an embodiment, the cloud resource 104 may be operable to send the game play data to the user data module 118 whenever a game state is finished, and optionally whenever there is a request from the user made via the first computing device 102. In an embodiment, the cloud resource 104 may be operable to store the game play data temporally in a memory thereof and send all the game play data to the user data module 118 after the user finishes playing the game.

In the situation where the user data module 118 cannot identify any stored game play data for the current user whose characteristics are to be determined, the user data module 118 may characterise the user as a novice. In an embodiment, the user data module 118 may group users in accordance with their competence levels in the game into different groups, e.g., novice-level group, intermediate-level group, expert-level group. Data indicating a competence level of a user may be provided by the user characteristic neural network module 108 (see below for more details). Where the user is characterised as a novice and thus there is no directly associated game play data, the user data module 118 may identify and send game play data associated with one or more other users who are in the same user group, e.g., the novice-level group. Alternatively or additionally, where the user provides input indicating their competence (even if there is no directly associated game play data), the user data module 118 may identify and send game play data associated with one or more other users are in the indicated user group, i.e. other novice-level, intermediate-level or expert-level users.

In other alternative or additional embodiments, the user data module 118 may group or classify game users according to metrics other than competence levels. Game users who, for instance, move a character more quickly or slowly than a given threshold value may be designated by the user data module 118 as quick or slow characters. A game user who tends to select a specific attack from a choice of attacks may be designated as a user who is likely to choose that attack.

In step 320, upon receiving the game play data associated with the user from the user data module 118, the user characteristic neural network module 108 may be operable to determine at least one characteristic of the user in the computer-generated gaming environment using a trained artificial intelligence model which has been trained to map the game play data associated with the user to the at least one characteristic of the user. In other words, the artificial intelligence model may be trained where the characteristics based on previous game play data are used as labels for outputs which correspond to the input of metrics associated with a game user’s interaction with a computer generated gaming environment. A set of metrics from a game user may indicate they are a novice user and that set of metrics can be labelled as such.

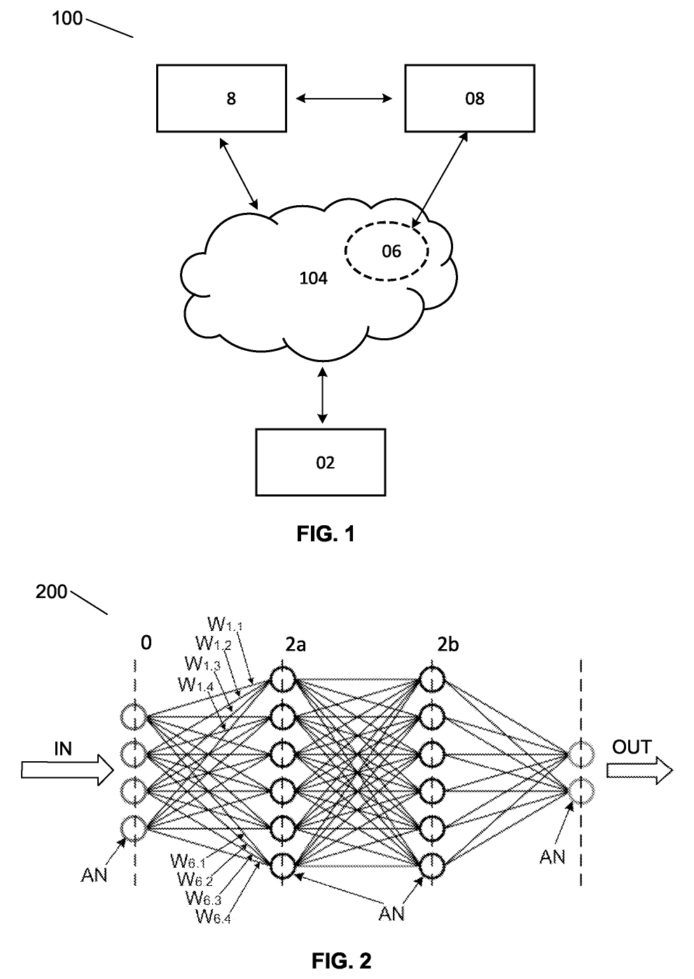

In an embodiment, the trained artificial intelligence model implemented by the user characteristic neural network module 108 may comprise a trained neural network model. With reference to FIG. 2, in an embodiment, the trained neural network model may comprise an artificial neural network (ANN) 200 also known as feedforward neural network. An ANN 200 is based on an interconnected group of artificial neurons ANs or nodes. The ANs are organized into multiple layers. ANs of one layer connect only to ANs of the immediately preceding and immediately following layers. The ANN 200 may be hardware (where neurons are represented by physical components) or software-based (computer models) and can use a variety of topologies and learning algorithms.

In the example ANN 200 shown in FIG. 2, the layer that receives input data IN is the input layer 110. The input data IN may comprise game play data provided by a user data module 118 which will be described in more detail below. The layer that outputs the final result is the output layer 114. The output data OUT may comprise one or more determined characteristics of the user which may be provided to the resource allocation module 106 to enable it to optimally allocate the computing resources of the system 100 for generating a game state in the computer-generated gaming environment.

In-between the input layer 110 and the output layer 114, there are two hidden layers 112a, 112b. In other example ANNs, there may comprise either no hidden layer or any other number of hidden layers (e.g., one, three, four or more hidden layers). Between any two neighbouring layers, ANs can be connected in many different ways, which may be used to determine the type of an ANN. The example ANN shown in FIG. 2 is a fully connected ANN, that is to say every AN in one layer is connected to every neuron in a neighbouring layer. In other examples such as pooling ANNs, a group of ANs in one layer are connected to a single AN in a neighbouring layer and as such the dimension of the neighbouring layer can be reduced.

With continued reference to FIG. 2, each AN has inputs and produces a single output which may be sent to multiple other ANs (see above). Each AN contains a vector of weights (e.g., weights W_{1.1}-W_{1.4} associated the top AN in the hidden layer 112a, weights W_{6.1}-W_{6.4} associated the bottom AN in the hidden layer 112a) of the same dimension as the input vectors wherein each weight determines the strength of the corresponding input. Each AN is configured to calculate the weighted sum of all the inputs using the weights associated with the respective input connections and add a bias to the weighted sum. The AN then passes such a biased weighted sum through an activation function (e.g., sigmoid function) to obtain the output signal. The weights are optimized using an optimization algorithm. The optimization process depends on the chosen optimization algorithm. A suitable optimization algorithm may be stochastic gradient descent (SGD). The objective of the optimization algorithm is to minimize a loss function (e.g., mean squared error (MSE)). The optimization algorithm may determine and update the model's weights in such a way that the loss function is as close to the minimum value as possible. The accuracy of the network may depend on the network structure (e.g., number of ANs, number of layers, and connection patterns between layers) and the optimization algorithm. The inputs to the AN may be based on an output from another AN.

In an embodiment, the method may further comprise training the neural network (e.g., the ANN 200) on training data to obtain the trained neural network, said training of the neural network model may comprise applying a stochastic gradient descent algorithm on said training data. Such training may be supervised, based on known input data (e.g., known game play data associated with a user) and corresponding characteristics of the user and may result in a set of optimal weights (e.g., weights W_{1.1}-W_{1.4} … W_{6.1}-W_{6.4} shown in FIG. 2).

The training of the neural network or any part of the neural network may be repeated at regular time intervals which are specified by a system operative and/or automatically as more game play data is obtained.

The training data may comprise historic game play data associated with one or more users who have played the computer game and may be provided by the user data module 118. Said one or more users may or may not include the one whose characteristics are to be determined by the user characteristic neural network module 108. The game play data may comprise multiple (e.g., four) subsets of data (e.g., an indication of a game state, a response action to the game state, a length of time taken to make the response action (or the response speed), and an amount of computing resources used to generate the game state). The strength of each subset of the input data may be governed by a weight optimally determined during the training stage. By inputting such input data to (e.g., the four ANs in) the input layer 110 of the neural network 200, the trained neural network (e.g., the trained ANN 200) is operable to infer or determine one or more characteristics of the user.

In an embodiment, the at least one characteristic of the user may comprise a competence level of the user in the computer-generated gaming environment. For example, based on the input game play data, the trained neural network (e.g., the trained ANN 200) may output a value indicating a level of competence of the user in playing the game provided in the computer-generated gaming environment. Other than the competence level, the at least one characteristic of the user may comprise indications that can directly or indirectly reflect a degree of familiarity of the user with the game. Such indications may comprise for example a total accumulated time the user has played the game to date, and/or a total number of game states the user has encountered in the game to date.

In another embodiment, the at least one characteristic of the user may comprise a responsiveness level (i.e. how quickly the user responds to a game state), an enquiry level (i.e. how much of a game state the user consumes) or an attack choice designation (i.e. that a user is likely to select a specific attack).

The user characteristic neural network module 108 may be operable to send the data in relation to the determined at least one characteristic of the user to the resource allocation module 106 of the cloud resource 104 which will use the data to optimally allocate computing resources for generating the game state based on the determined at least one characteristic of the user resources for generating the next game state. The user characteristic neural network module 108 may be operable to also send the data in relation to the determined at least one characteristic of the user to the user data module 118 which will store or update the data as part of the game play data associated with the user.

In the case of a new user who is playing the game for the first time, the user data module 118 may not contain any game play data (e.g., a response action made to a specific game state) associated with the new user. As such, the user data module 118 may characterise the new user as a novice and may send game play data associated with one or more other users who have played the game but are still characterised by the user data module 118 as novices.

However, while the user becomes more familiar with the game (e.g., after spending more time playing the game), the length of time the user needs to move through different game states may be shortened and correspondingly the computing resources required for generating such game states may be reduced. When such game play data is then provided to the user characteristic neural network module 108, the trained neural network (e.g., the trained ANN 200) implemented by the user characteristic neural network module 108 may determine that the user has an increased level (e.g., increased from previous novice level to current intermediate/expert level) of competence in playing the game. This data in relation to the user’s competence level may then be sent to the user data module 118 which will update the corresponding game play data in the database.

In another embodiment, a user who is identified by the neural network as being more inquisitive inside a game state will have their allocated computing resources increased as it is likely that more of the audio and visual cues within the game state will need to be rendered.

In another embodiment, a user who is identified by the neural network as likely to select a specific attack will have their allocated computing resources optimised for the specific attack.

In step 330, the resource allocation module 106 of the cloud resource 104 may be operable to allocate computing resources of the system 100 for generating the game state based on the determined at least one characteristic of the user. The computing resources may include for example a dedicated portion of the processing power of the cloud resource 104 and the first computing device 102, a portion of the memory of the cloud resource 104.

Where some resources have allocated graphics capability, more or less graphic generation resource may be generated for game users who are identified as likely needing more or less respectively.

In an embodiment, the at least one characteristic of the user may comprise a competence level of the user in the computer-generated gaming environment. For example, when the user is determined to be a novice, the resource allocation module 106 may be operable to allocate more computing resources for generating the next game state. Whereas, when the user is determined to be an expert, the resource allocation module 106 may be operable to allocate less computing resources for generating the next game state. This way of allocating computing resources may be based on the fact that a novice-level player tends to spend more time exploring a game state than an expert-level player and therefore would need the game state to be more thoroughly rendered.

In an embodiment, the resource allocation module 106 may be operable to determine at least one aspect of the game state that would impact the required computing resources. Said at least one aspect of the game state may comprise one or more of the following: presence of one or more visual components of the game state, presence of one or more audio components of the game state, presence of one or more tactile cues of the game state, and a rendering resolution of one or more visual components of the game state. Visual components may be for example parts of a background and/or foreground image of the game state. Audio components may be for example a background sound or other sound effects of the game state. Tactile cues may be for example vibrations of the first computing device 102.

By way of example, when the user is determined to be a novice, the resource allocation module 106 may allocate more computing resources such that the next game state will be rendered in a more thoroughly manner. This may be implemented by rendering more parts (e.g., one or more visual components, and/or one or more audio components, and/or presence of one or more tactile cues) of the game state, and/or by rendering at least some parts (e.g., one or more visual components) of the game state with a higher rendering resolution. By contrast, when the user is determined to be an expert, the resource allocation module 106 may allocate less computing resources such that the next game state will be rendered less thoroughly. This may be implemented by rendering less parts of the game state, and/or rendering at least some parts of the game state with a lower/minimal rendering resolution.

In step 340, the cloud resource 104 may be operable to generate the game state in the computer-generated gaming environment based on the determined at least one aspect of the game state.

In an embodiment, to generate the game state in the computer-generated gaming environment, the cloud resource 104 may be operable to obtain multimedia content associated with the game state in accordance with the determined at least one aspect of the game state. For example, the cloud resource 104 may obtain the multimedia content from a local and/or remote memory. The multimedia content may comprise one or more visual components, and/or one or more audio components, and/or one or more tactile cues. Which components of the multimedia content shall be rendered and how they shall be rendered will depend on the determined at least one aspect of the game state.

Eventually, the cloud resource 104 may be operable to render said multimedia content of the game state.

Although particular embodiments of this disclosure have been described, it will be appreciated that many modifications/additions and/or substitutions may be made within the scope of the claims.

It should be noted that the above-mentioned aspects and embodiments illustrate rather than limit the disclosure, and that those skilled in the art will be capable of designing many alternative embodiments without departing from the scope of the disclosure as defined by the appended claims. In the claims, any reference signs placed in parentheses shall not be construed as limiting the claims. The word "comprising" and "comprises", and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented method comprising:
obtaining game play data associated with a user;
determining at least one characteristic of the user in the computer-generated gaming environment using a trained artificial intelligence model which has been trained to map the game play data associated with the user to the at least one characteristic of the user;
allocating computing resources for generating a game state based on the
determined at least one characteristic of the user; and
generating the game state in the computer-generated gaming environment using
using the allocated computing resources.

2. The computer-implemented method of claim 1, wherein the trained artificial intelligence model comprises a trained neural network model.

3. The computer-implemented method of claim 2, wherein the trained neural network model is a feedforward neural network model.

4. The computer-implemented method of claim 2, comprising training the neural network model on training data to obtain the trained neural network model.

5. The computer-implemented method of claim 4, wherein training the neural network comprises applying a stochastic gradient descent algorithm on the training data.

6. The computer-implemented method of claim 4, wherein the neural network model is trained using supervised learning or reinforcement learning.

7. The computer-implemented method of claim 1, wherein the game play data associated with the user comprises inputs of the user in response to one or more game states provided as part of a computer game in the computer-generated gaming environment.

8. The computer-implemented method of claim 7, wherein the game play data associated with the user further comprises one or more indications respectively indicating the one or more game states.

9. The computer-implemented method of claim 7, wherein the game play data associated with the user comprises data indicating a length of time taken by the user to provide inputs in response to each of the one or more game states.

10. The computer-implemented method of claim 7, wherein the game play data associated with the user further comprises data indicating an amount of computing resources used to generate each of the one or more game states.

11. The computer-implemented method of claim 1, wherein the at least one characteristic of the user comprises a competence level of the user in the computer-generated gaming environment.

12. The computer-implemented method of claim 1, wherein allocating computing resources for generating the game state based on the determined at least one characteristic of the user comprises determining at least one aspect of the game state.

13. The computer-implemented method of claim 12, wherein the at least one aspect of the game state comprises one or more of:
a presence of one or more visual components of the game state;
a presence of one or more audio components of the game state;
a presence of one or more tactile cues of the game state; and
a rendering resolution of one or more visual components of the game state.

14. The computer-implemented method of claim 13, wherein generating the game state in the computer-generated gaming environment comprises:
obtaining multimedia content associated with the game state, said multimedia content being determined by the allocated computing resources; and
rendering said multimedia content of the game state.

15. The computer-implemented method of claim 14, wherein the multimedia content comprises one or more visual components.

16. The computer-implemented method of claim 14, wherein the multimedia content comprises one or more audio components.

17. The computer-implemented method of claim 14, wherein the multimedia content comprises one or more tactile cues.

18. One or more non-transitory computer-readable media storing software comprising instructions that are operable, when executed by one or more computers, to cause the one or more computers to perform operations comprising:
obtaining game play data associated with a user;
determining at least one characteristic of the user in a computer-generated gaming environment using a trained artificial intelligence model which has been trained to map the game play data associated with the user to the at least one characteristic of the user;
allocating computing resources for generating a game state based on the determined at least one characteristic of the user; and
generating the game state in the computer-generated gaming environment using
using the allocated computing resources.

19. The one or more non-transitory computer-readable media of claim 18, wherein the trained artificial intelligence model comprises a trained neural network model.

20. A system comprising:
one or more computers and one or more storage devices storing instructions that are operable, when executed by the one or more computers, to cause the one or more computers to perform operations comprising:
obtaining game play data associated with a user;
determining at least one characteristic of the user in a computer-generated gaming environment using a trained artificial intelligence model which has been trained to map the game play data associated with the user to the at least one characteristic of the user;
allocating computing resources for generating a game state based on the determined at least one characteristic of the user; and
generating the game state in the computer-generated gaming environment using the allocated computing resources.
